(19) United States
(12) Patent Application Publication
(10) Pub. No.: US 2007/0267859 A1
(43) Pub. Date: Nov. 22, 2007

(54) Service order payment and receipt form set

(76) Inventor: David A. Milman, Jamesville, NY (US)

Correspondence Address: BERNHARD P. MOLLDREM, JR., 224 HARRISON STREET, SUITE 200, SYRACUSE, NY, 13202, US

(21) Appl. No.: 11/437,445

(22) Filed: May 19, 2006

(51) Int. Cl. B42D 1/00

(52) U.S. Cl. 281/15.1

(57) ABSTRACT

A form set used by technicians on service calls premit the technician to record the entire transaction. A pad of business forms sets combine the technician's service order, customer receipt, next appointment reminder, customer comment post card, credit card impression area, statement(s) of terms and conditions. The form set guides the technician through the customer interaction, captures all the required information, and provides a mechanism for customer feedback.

### BACKGROUND OF THE INVENTION

This invention concerns business forms, and is particularly concerned with a set of order and receipt forms to facilitate dealings between service providers, e.g., repair technicians, and customers. The invention is more specifically directed to a pad of form sets that guide the service provider through the transaction with the customer, provide all the information that the customer will need, provide spaces for recording all the services and merchandise that is sold to the customer, as well as providing means for recording payment of various types, scheduling of any follow-up work, and means for customer feedback.

Currently, business owners and operators provide their service personnel with work orders, receipt forms, and other items associated with customer contact, and normally these are all provided as separate forms. It is desirable to provide the service personnel, who are the ones who contact customers directly, with an all-in-one business form that facilitates complete recording of the transaction, and provides the customer with all the required information about the services and merchandise-provided, any scheduled follow up work, and all terms and conditions of service together with statements of warranties. It is also desired that the technician be provided a checklist to ensure complete delivery of effective service to the customer, and to provide the customer with a means of providing comments and rating of the quality of the service being provided. However, to date, these items have not been available on a single form set.

### OBJECTS AND SUMMARY OF THE INVENTION

Accordingly, it is a principal object of the present invention to provide a set of business forms that combine the technician's service order, customer receipt, next appointment reminder, customer comment post card, credit card impression area, statement(s) of terms and conditions, and other features into a set of forms that are convenient for the technician's use in dealing with customers and capture all the required information.

More particularly, it is an object to provide a business form set that facilitates the business interaction between the technician and the customer, which facilitates making a complete record of the transaction, and which avoids the drawbacks and shortcomings of the current techniques.

It is a related object to provide a pad of form sets in which each form set provides spaces for recording all the required information for each customer transaction, and which provides the required information to each of the customer and the provider or merchant.

According to an aspect of this invention, a service call customer receipt form pad comprising a series of form sets, and each form set has at least a merchant sheet and a customer sheet, the latter being situated immediately behind the merchant sheet on the pad. There can be a third sheet, for example containing marketing or promotional materials, behind the customer sheet. The merchant sheet and the customer sheet are each marked with a sequential receipt number or sequence number.

In one implementation, the merchant sheet or merchant copy, at an upper portion, has a first printed area with spaces for entering customer name and address information; a second printed area for entering service technician identification information; an invoice area for entering services and merchandise to be provided to the customer, with corresponding spaces for entering quantities, prices, and amounts due; a payment data area for entering mode of customer payment, customer credit card data, and customer signature. Below this, on a lower portion there is an appointment scheduling area with entry spaces for entering date and time of a next scheduled appointment for the customer. At a lower corner of the merchant sheet there is a credit card imprint area for taking an impression of a credit card of the customer. A technician checklist area, also located on the lower portion of the merchant sheet, containing a series of printed checklist items and corresponding check boxes for the technician to enter a mark for each item.

The customer sheet or customer copy has a first printed area, a second printed area, an invoice area, a payment data area, and an appointment scheduling area, which have the same entry spaces as the corresponding areas on the merchant sheet and are in register with them, i.e., are located directly behind those areas of the merchant sheet. Also at the lower portion of the customer sheet below the invoicing and payment areas there is a customer rating and comment post card. This is most favorably formed on an area of the customer sheet corresponding to the location of the technician checklist area on the merchant sheet. The customer rating and comment post card should be in the form of a postage-paid self-addressed postal card. The appointment scheduling area of the customer sheet being in the form of a separable tear-off appointment reminder slip.

At the upper portions and on the reverse sides of both the merchant sheet and the customer sheet there are identical printed statements of terms and conditions. On the reverse of the merchant sheet aligned with said technician checklist there is a service call notes area providing space for the technician to enter notes concerning the service call.

The form set is provided with a carbonless copy mechanism for copying the entries made in the first, second, invoice, payment, and appointment scheduling areas onto the customer sheet. This can involve having the reverse of the merchant sheet provided with a coating of a first material at areas behind the first and second printed areas, the invoice area, the payment data area, and the appointment scheduling area; and likewise providing the customer receipt form sheet with a coating of a second or complementary material at the corresponding areas, such that the pressure of writing onto the merchant sheet produces visible writing on the customer sheet. The copying system is omitted from areas corresponding to the credit card imprint area and the technician checklist area, so the entries here do not copy onto the customer sheet. Alternatively, a carbon sheet can be interposed between the merchant sheet and the customer sheet provided with carbon for the areas as mentioned above where the entries are to be copied also onto the customer sheet.

Each form set on the pad has a sequence number, and this number is imprinted on the merchant sheet and on the customer sheet, with a different receipt number or sequence number on each form set on the pad. (This sequence number can be numeric or alphanumeric.) The sequence number is most preferably also imprinted onto the customer rating and comment card, so that the comments can be associated later on with the particular service technician and with the particular customer.

As mentioned before, each form set can also include a third sheet positioned behind the customer sheet. This third sheet may contain information concerning other products and services. In one preferred embodiment, this third sheet can also include a tear-off or separable discount referral coupon which has spaces for entering customer identification and for entering name and address of a referred prospective customer. The customer sheet and the promotional sheet may be formed of a card stock paper.

A front cover of the pad or book has a place for the name of the service technician. The back cover is most favorably of double length, so the lower part can be folded over to fit between the top form set and the form set behind it. On the upper part of the inside back cover is a table for the technician to enter, for each form set or for a sequence of the form sets, the date, the form set sequence number (or the last number in the series or sequence that is being accounted for), the number of receipt form sets, and the technician's initials. Preferably, there is a place for the owner's or supervisor's initials as well, so the owner or supervisor can record that an inspection of the book has been completed. In the embodiment described below, the lower part of the inside cover contains check authorization procedures to facilitate payment authorization and processing for those customers who choose to pay by check or bank draft. The printed check authorization procedures provide all the information the technician may need to ensure proper check authorization. This information is in a convenient place for the technician to refer to for this.

The lower half of the outside rear cover may preferably include the printed statement of terms and conditions (which can be identical to the terms and conditions that are printed on the reverse sides of the merchant sheet and the customer sheet). This is printed in an inverted format (i.e., upside-down) so that when the back cover is folded over as a divider between form sets, the terms and conditions will appear in normal format or right-side-up. This provides further positive assurance that the customer is afforded as much information as he or she might need about the conditions of service, and about any guarantees and warranties, and facilitates the technician's ability to answer any customer questions in that regard.

A clear advantage of this system of form sets over the common practice is that it ensures all customers are provided with a record of the transaction containing all needed information concerning the delivery of products and services, and ensures that the technician follows all required procedures, obtains payment correctly, and provides the customer with information any scheduled subsequent service calls where scheduling is indicated. The pad of form sets of this invention provides all the information and spaces to record the transaction at one place. This avoids having to keep several sets of forms on hand, and with the entire transaction recorded on one place, this form set facilitates the service provider's review and auditing functions later on.

By facilitating the proper and correct entry of all required information with these business forms, the technician can focus on the efficient technical delivery of services and products to the customer.

The above and many other objects, features, and advantages of this invention will be more fully appreciated from the ensuing description of a preferred embodiment, which is to be read in conjunction with the accompanying Drawing.

### BRIEF DESCRIPTION OF THE DRAWING

FIG. 1 is a perspective view of a form set pad according to one embodiment of this invention.

FIG. 2A shows a front side of a first or merchant sheet of the form set of this embodiment.

FIG. 2B shows the reverse side of the merchant sheet.

FIG. 3A shows a front side of a second or customer sheet of the form set of this embodiment.

FIG. 3B shows the reverse side of the customer sheet.

FIGS. 4A and 4B show front and reverse sides of a third or promotional sheet of the form set of this embodiment.

FIG. 5 shows a front or inside of a double-length back cover sheet for the pad or book of form sets.

FIG. 6 shows the back or outside thereof.

FIG. 7 shows a front cover sheet of the pad or book.

### DETAILED DESCRIPTION OF THE PREFERRED EMBODIMENTS

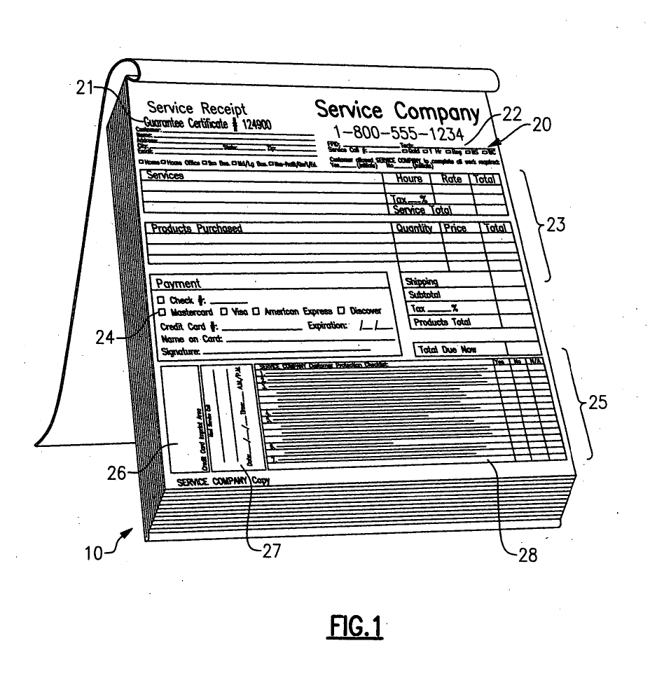

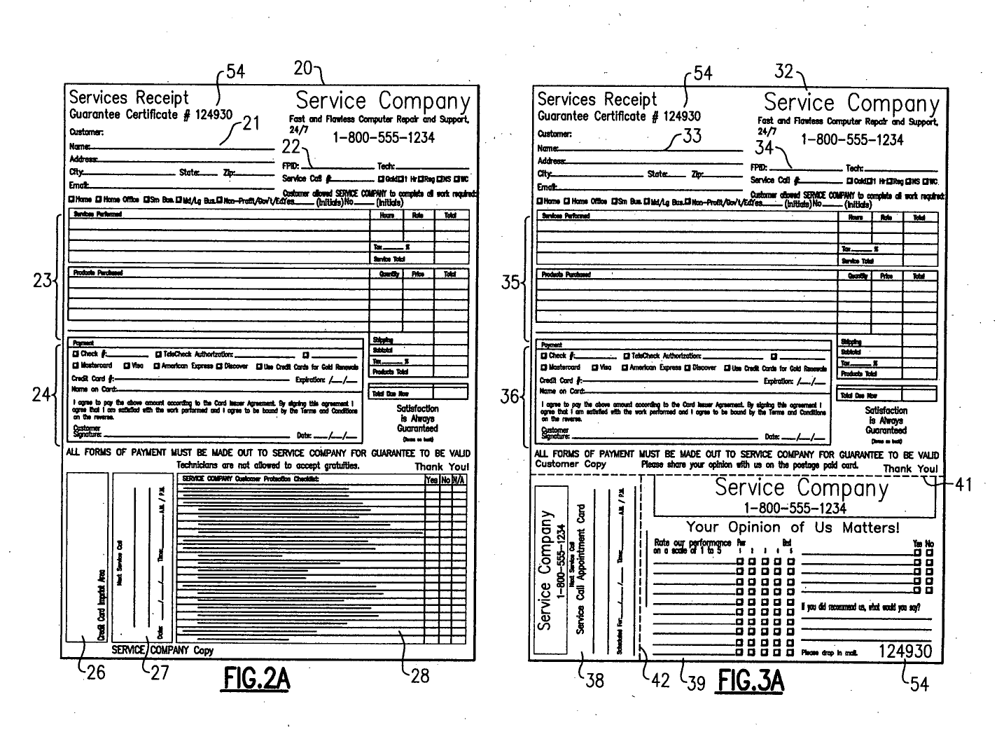

With reference now to the Drawing, FIG. 1 shows a pad 10 containing multiple sets of customer transaction forms, each form set having a top or merchant sheet 20, a second or customer sheet, and a third sheet containing promotional material and other information, and which also serves as a spacer between the customer sheet and the merchant sheet of the next form set. The merchant sheet 20, i.e., the technician or company copy, is also shown in FIGS. 2A and 2B, where FIG. 2A shows the front of the merchant sheet 20, and FIG. 2B shows the back or reverse.

The sheet 20 is imprinted so as to define various printed areas that are to be filled in by the technician when making a service call to a customer.

In a preferred embodiment, the merchant sheet or technician sheet 20 has imprinted on it a number of areas for entry of various types of information regarding the customer transaction. At the upper left of the sheet 20 is a customer information area 21 for the technician to enter customer name, address, telephone, and email, and at the upper right is a service technician information area 22, where the technician enters his or her name and identification number, service call number, type of service call, etc. There are also spaces for indicating whether the technician was able to complete all the required work.

Below the areas 21 and 22 is an invoicing area 23, where there are imprinted spaces for listing the services provided to the customer, the merchandise or products purchased by the customer, and spaces for hours, rate, and total fee (for services) and quantity, price, and total (for products). Spaces are also provided here for shipping, and tax, as applicable, with subtotals and a grand total. At the left of the totals portion of the area 23 the form provides a printed payment area 24, for entering the customer's form of payment for the goods and services. In this embodiment, this area has check boxes for payment by check and for various types of credit or debit card, with spaces for entry of card number, expiration date, cardholder name, and a space for the customer's signature.

A bottom portion 25 of the sheet 20 is imprinted with areas for entering additional information connected with the customer transaction, so all the necessary places are on the same form. Here at the left corner is a credit card imprint area 26 that provides a place for imprinting the customer's credit card information directly onto the technician sheet 20. In this case, the card imprint area 26 is an open rectangle, not printed except for a small legend indicating that this is the credit card imprint area.

Just to the right of the area 26 is an appointment scheduling area 27, where the technician can enter the date and time of a next appointment, where there is any follow-up work needed. There are spaces provided for the time and date of the scheduled appointment, and there may be blank lines for other information as well, e.g., name of technician and identification of service to be provided at that time. Then the right-hand portion of the lower portion 25 of the form sheet is occupied by a technician checklist 28, where there are listed a number of steps that the technician is to follow on the service call, and associated check boxes for the technician to mark, as appropriate for each checklist item. Here, the check boxes are provided for YES, NO, and N/A. The printed text for the various checklist items are represented here by simple lines for the sake of simplicity of drawing.

As shown in FIG. 2B, the reverse of the technician sheet 20 is provided with a list of printed terms and conditions 29. These occupy the portions of the form sheet that is directly behind the areas 21, 22, 23 and 24. Any guarantees and warranties, as well as limitations on the service are listed here. Below this, on the portion of the form behind the areas 26, 27, and 28, is a technician notes area 30, which is a rectangular space that is left mostly open for entry of notes concerning the service call visit, but with spaces for entry of date and time of visit, or other items that may be appropriate to the customer or to the service call.

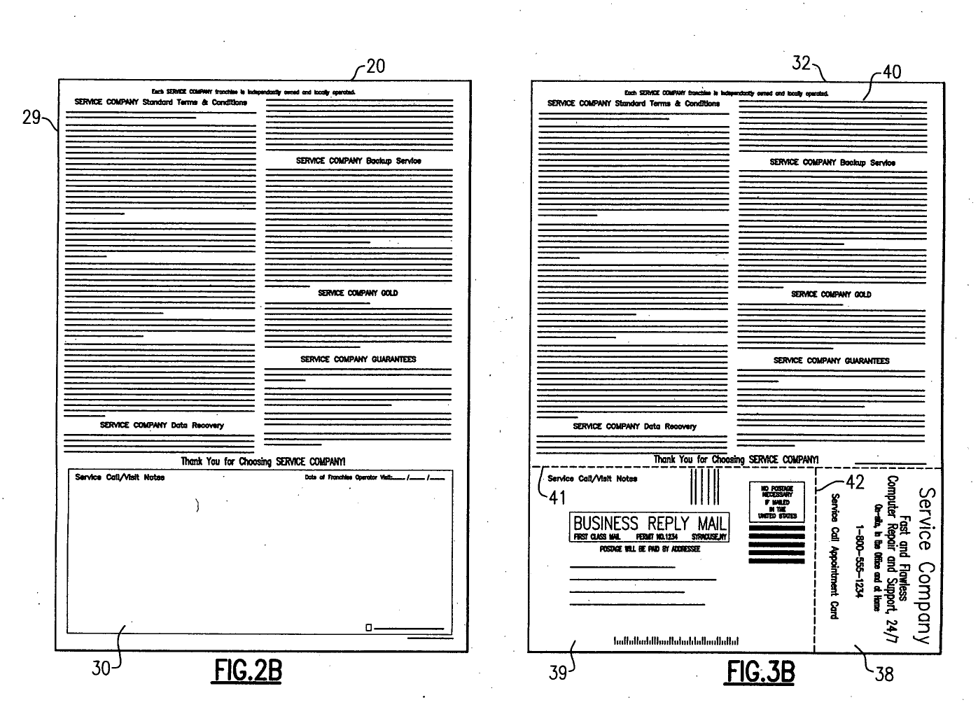

Immediately behind the merchant sheet or technician sheet 20 is a customer receipt sheet or customer copy 32, the front of which is shown in FIG. 3A. This includes a customer data area 33, a technician data area 34, an invoicing area 35 and a payment area 36, which contain spaces that are identical to those provided in corresponding areas 21, 22, 23 and 24 on the technician sheet 20, and are in register with those areas so the information written on the technician sheet 20 will copy onto the corresponding spaces on the customer receipt sheet 32.

Below the above areas there is a service call reminder card 38 with spaces aligned with the appointment scheduling area 27, so that the follow-up appointment information written in the latter will be identically copied onto the reminder card 38. To the right of this is customer rating and comment postcard 39, which is printed on the back (See FIG. 3B) with the company address and postage information; that is, the rating and comment card 39 is in the form of a tear-off or separable self-addressed postage-paid postcard. The front side of the card 39 has a list of rating items and check boxes for the customer to mark to indicate the level of quality of service as perceived by the customer. The text of these rating items is represented here by lines for sake of drawing simplicity.

On the rear or reverse of the customer receipt form 32 is a statement of terms and conditions 40 that is identical to the terms and conditions 29 that are printed on the top form sheet, i.e., the technician or merchant sheet 20.

Favorably, the customer receipt form sheet 32 is printed on a card stock, i.e., a fairly stiff paper. The sheet 32 is also provided with perforations 41 and 42, so that the appointment reminder card 38 and the rating and comment card 39 can be torn off from the remainder of the sheet 32.

Both the technician form sheet 20 and the customer receipt form sheet 32 are imprinted with a sequence number 54, which is identical for these two form sheets of the form set, and will be a different number for each successive form set on the pad 10 or pack of forms. This sequence number assists in tracking or auditing. In this implementation, the sequence number 54 appears in the customer data areas 21 and 33. The same sequence number 54 also appears on the rating and comment card 39, so that the company can associate the customer's comments with the particular service order.

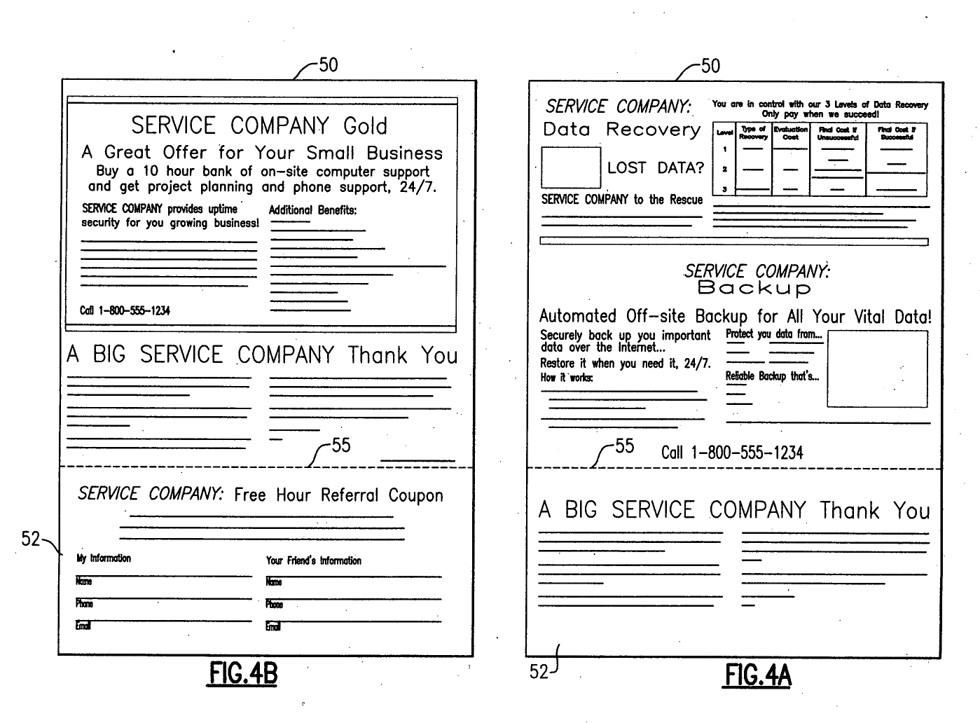

Also in this embodiment, each form set has a third sheet 50, shown front and rear in FIGS. 4A and 4B. Here the sheet 50 serves as a separator or spacer between successive form sets, and also contains promotional information, e.g., information concerning programs and benefits that the company offers that may be of interest to the customer. This sheet 50 may be of a heavy grade of paper or of cardstock. At the lower part of the sheet 50 is separable referral coupon, with an offer for additional services at a reduced rate, and with spaces for entry of the customer identification and for identification of a possible new customer, i.e., referral. There is a horizontal perforation line 55 that allows the coupon 52 to be torn off and redeemed, e.g., at a subsequent service call.

Preferably, the form sheets 20 and 32 are provided with a carbonless copying system so that pressure of writing into the areas 21, 22, 23, 24 and 27 on the technician sheet will result in the writing appearing in the corresponding locations in the areas 33, 34, 35, 36, and 38 on the customer receipt sheet 32. Typically this involves providing a coating on the reverse of the sheet 20 at the locations aligned with the areas 21, 22, 23, 24 and 27, and a complementary coating applied onto the front face of the form sheet 32 on the areas 33, 34, 35, 36 and 38. Because the marks on technician checklist 28 are not to be copied onto the front of the customer rating and comment card 39, the coatings are omitted on those areas.

In alternative implementations, a carbon sheet can be used for impressing the writing on the technician sheet 20 onto the corresponding areas of the customer sheet 32.

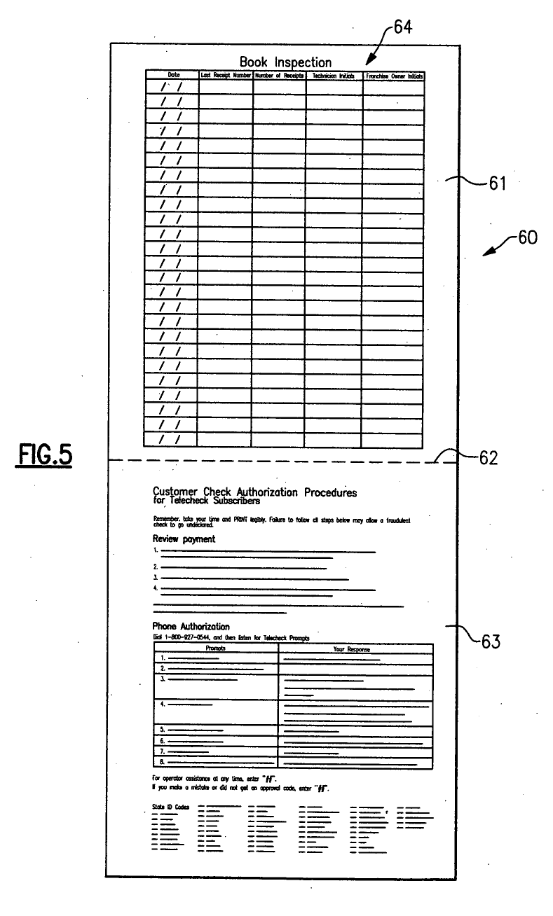

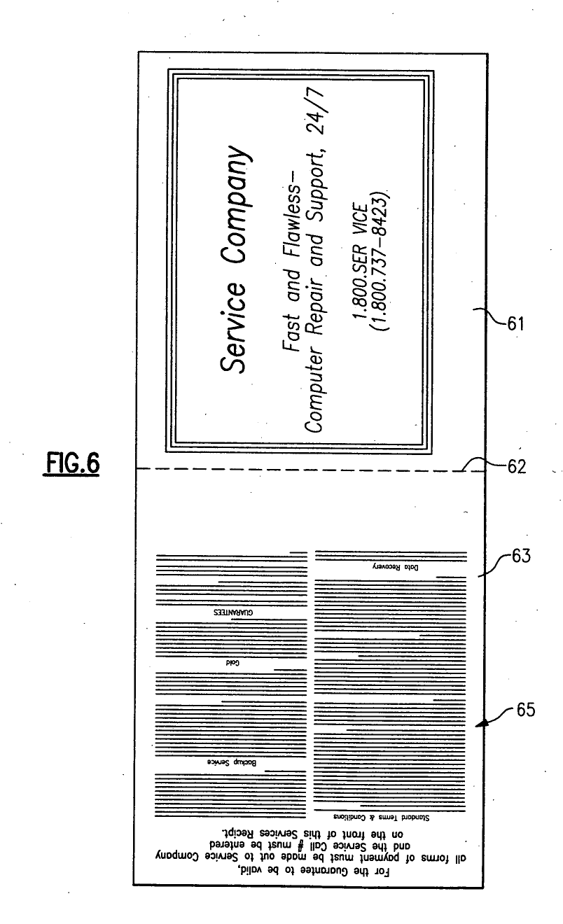

FIGS. 5 and 6 show the inside and outside, respectively, of a back cover sheet 60 of the form set book or pad 10. The cover is of double length, i.e., twenty-two inches, with a top or upper half 61 that is separated, by a horizontal fold line 62, from a bottom or lower half 63. On the inside back cover (FIG. 5) the top half 61 is imprinted with a table 64 for the technician to enter the dates, sequence numbers of the receipt form used, the technician's initial, and the date, and also provides spaces for the supervisor, e.g., franchise owner, to enter his or her initials. This table 64 is a provision to ensure a proper paper audit or accounting for the form sets that are issued to the customer by the technician.

At the bottom or lower half 63 are imprinted check processing and check authorization procedures, including all the steps the technician needs to take to verify the check and to obtain authorization by telephone (or on-line). By listing all the steps for check authorization here in the form set book 10, the pad or book 10 gives technician a ready reference so that all check payments can be taken care of properly and quickly.

As shown in FIG. 6, on the outer side of the back cover lower half 63, there is imprinted a statement 65 of terms and conditions. These are a repeat of the terms and conditions that appear as provided on the reverses 29 and 40 of the merchant sheet 20 and the customer sheet 32. This lower portion 63 of the back cover is usually folded forward at the fold line 62 so it can be used as a separator between the receipt form set being used for the customer and the next form set in sequence. Accordingly, the imprinted material is printed in inverted fashion, as shown in FIG. 6, so that when the lower back cover is in place as a divider, the terms and conditions will appear right side up. These serve as a reference for the technician to help him or her answer any customer questions concerning the conditions of service or about any warranties or guarantees or other services or products that the company may provide. These may be identical with the materials printed on the reverse sides of the merchant and customer sheets, as here, or may include additional items, as appropriate.

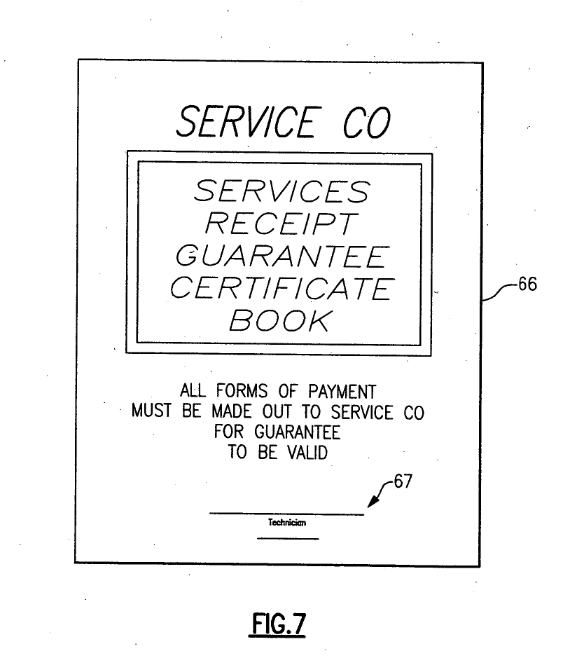

FIG. 7 shows an example of a front cover 66 for the form book or pad 10. Here, the front cover has a space 67 for entering the technician name or identity number or code for the technician to whom the particular sequence of form number in that form book is assigned. Each form set in the form book 10 has a unique number, and all the form books or pads 10 have a unique series of sequence numbers.

While the form set in this embodiment is intended for use in a computer and network repair and data restoration business, the forms can be adapted for use in many fields of business. Also, the printed areas may appear at other portions of the forms than where specifically shown here, and there may be additional information provided, as appropriate.

While the invention has been described with reference to a specific preferred embodiment, the invention is certainly not limited to that precise embodiment. Rather, many modifications and variations will become apparent to persons of skill in the art without departure from the scope and spirit of this invention, as defined in the appended claims.

1. A service call customer receipt form pad comprising a series of form sets, in which each form set includes a plurality of sheets with a merchant sheet and a customer sheet situated immediately behind the merchant sheet on the pad;
said merchant sheet including
at an upper portion thereof a first printed area with spaces for entering customer name and address information; a second printed area for entering service technician identification information; an invoice area for entering services and merchandise to be provided to the customer, with corresponding spaces for entering quantities, prices, and amounts due; a payment data area for entering mode of customer payment, customer credit card data, and customer signature; and
at a lower portion thereof an appointment scheduling area with entry spaces for entering date and time of a next scheduled appointment for the customer; at one corner thereof a credit card imprint area for taking an impression of a credit card of the customer, and a technician checklist area containing a series of printed checklist items and corresponding check boxes for the technician to enter a mark;
said customer sheet including a first printed area, a second printed area, an invoice area, a payment data area, and an appointment scheduling area, which have the same entry spaces as the corresponding areas on the merchant sheet and are in register with them, with a line of perforations defining a lower portion of the customer sheet, containing a customer rating and comment card and the appointment scheduling area of the customer sheet;
the customer rating and comment post card being formed on an area of the customer sheet corresponding to the location of the technician checklist area on the merchant sheet; the customer rating and comment post card being in the form of a postage-paid self-addressed postal card and having a merchant address and postal information on the reverse side thereof; and
the appointment scheduling area of the customer sheet being in the form of a separable tear-off appointment reminder slip, with another line of perforations separating the appointment reminder slip from the customer rating and comment post card.

2. The service call customer receipt form pad of claim 1 wherein an upper portion of reverse sides of said merchant sheet and said customer sheet include identical printed statements of terns and conditions.

3. The service call customer receipt form pad of claim 1 wherein a reverse of the merchant sheet aligned with said technician checklist includes a service call notes area providing space for the technician to enter notes concerning the service call.

4. The service call customer receipt form pad of claim 1 wherein a reverse of the merchant sheet is provided with a coating of a first material at areas behind said first and second printed areas, said invoice area, said payment data area, and said appointment scheduling area, and wherein the customer sheet is provided with a coating of a second material at the corresponding areas thereof, such that the pressure of writing onto the merchant sheet produces visible writing on the customer sheet.

5. The service call customer receipt form pad of claim 4 wherein said coatings are omitted from areas corresponding to the credit card imprint area and the technician checklist area.

6. The service call customer receipt form pad of claim 1 wherein each form set includes a sequence number imprinted thereon on the merchant sheet and on the customer sheet, with a different sequence number on each form set on the pad.

7. A service call customer receipt form pad comprising a series of form sets, in which each form set includes a plurality of sheets with a merchant sheet and a customer sheet situated immediately behind the merchant sheet on the pad:
said merchant sheet including
at an upper portion thereof a first printed area with spaces for entering customer name and address information; second printed area for entering service technician identification information; an invoice area for entering services and merchandise to be provided to the customer, with corresponding spaces for entering quantities, prices, and amounts due; a payment data area for entering mode of customer payment, customer credit card data, and customer signature; and
at a lower portion thereof an appointment scheduling area with entry spaces for entering date and time of a next scheduled appointment for the customer; at one corner thereof a credit card imprint area for taking an impression of a credit card of the customer; and a technician checklist area containing a series of printed checklist items and corresponding check boxes for the technician to enter a mark;
said customer sheet including a first printed area, a second printed area, an invoice area, a payment data area, and an appointment scheduling area, which have the same entry spaces as the corresponding areas on the merchant sheet and are in register with them;
a customer rating and comment post card formed on an area of the customer sheet corresponding to the location of the technician checklist area on the merchant sheet; the customer rating and comment post card being in the form of a postage-paid self-addressed postal card; and
the appointment scheduling area of the customer sheet being the form of a separable tear-off appointment reminder slip;
wherein each form set includes a unique sequence number imprinted thereon on the merchant sheet and on the customer sheet, with a different sequence number on each form set on the pad, and wherein each form set has said unique sequence number imprinted onto the customer rating and comment card thereof.

8. The service call customer receipt form pad of claim 1 wherein each form set includes a third sheet positioned behind the customer sheet, and containing information concerning other products and services.

9. The service call customer receipt form pad of claim 8 wherein said third sheet includes a discount referral coupon that is separable from the third sheet and includes spaces for entering customer identification and for entering name and address of a referred prospective customer.

10. The service call customer receipt form pad of claim 1 wherein said customer sheet is formed of a card stock paper.

11. The service call customer receipt form pad of claim 1 further comprising a back cover sheet that is of double length and having a horizontal fold line therein.

12. The service call customer receipt form pad of claim 11 wherein an upper half of said back cover sheet is imprinted with a table containing spaces for entering sequence numbers of form sheets used, date, and technician identification.

13. The service call customer receipt form pad of claim 11 wherein a lower half of said back cover sheet is imprinted on an inner side thereof with instructions for check authorization.

14. The service call customer, receipt form pad of claim 11 wherein an outer side of a lower half of said back cover sheet is imprinted with a printed statement of terms and conditions.

15. The service call customer receipt form pad of claim 14 wherein said printed statement of terms and conditions is inverted.

16. A service call customer receipt form pad comprising a series of form sets, in which each form set includes a plurality of sheets with a merchant sheet and a customer sheet situated immediately behind the merchant sheet on the pad;
said merchant sheet including
at an upper portion thereof a first printed area with spaces for entering customer name and address information; a second printed area for entering service technician identification information; an invoice area for entering services and merchandise to be provided to the customer, with corresponding spaces for entering quantities, prices, and amounts due; a payment data area for entering mode of customer payment, customer credit card data, and customer signature; and
at a lower portion thereof an appointment scheduling area with entry spaces for entering date and time of a next scheduled appointment for the customer; at one corner thereof a credit card imprint area for taking an impression of a credit card of the customer; and a technician checklist area containing a series of printed checklist items and corresponding check boxes for the technician to enter a mark;
said customer sheet including a first printed area, a second printed area, an invoice area, a payment data area, and an appointment scheduling area, which have the same entry spaces as the corresponding areas on the merchant sheet and are in register with them;
a customer rating and comment post card formed on an area of the customer sheet corresponding to the location of the technician checklist area on the merchant sheet; the customer rating and comment post card being in the form of a postage-paid self-addressed postal card; and
the appointment scheduling area of the customer sheet being in the form of a separable tear-off appointment reminder slip;
wherein a reverse of the merchant sheet is provided with a coating of a first material at areas behind said first and second printed areas, said invoice area, said payment data area, and said appointment scheduling area, and wherein the customer sheet is provided with a coating of a second material at the corresponding areas thereof, such that the pressure of writing onto the merchant sheet produces visible writing on the customer sheet, and wherein said coatings are omitted from areas corresponding to the credit card imprint area and the technician checklist area, such that writing on the technician checklist area of the merchant sheet does not transfer onto the front of the customer rating and comment post card that is situated directly behind it, leaving the space available for entry of a customer's comments concerning the particular service order.
